(19) United States
(12) Patent Application Publication
(10) Pub. No.: US 2014/0211336 A1
(43) Pub. Date: Jul. 31, 2014

(54) AUTOMATIC GAIN CONTROL LOOP ADAPTATION FOR ENHANCED NYQUIST DATA PATTERN DETECTION

(71) Applicant: LSI CORPORATION, San Jose, CA (US)

(72) Inventors: Yu Liao, Longmont, CO (US); Haotian Zhang, Longmont, CO (US); Haitao Xia, San Jose, CA (US)

(73) Assignee: LSI Corporation, San Jose, CA (US)

(21) Appl. No.: 13/755,117

(22) Filed: Jan. 31, 2013

(51) Int. Cl. G11B 5/02

(52) U.S. Cl. CPC G11B 5/02
USPC 360/40; 360/46

(57) ABSTRACT

Techniques are provided for automatic gain control loop adaptation in circuitry for processing such data signals. In one example, an apparatus comprises read channel circuitry and signal processing circuitry associated with the read channel circuitry. The signal processing circuitry comprises an amplifier, a detector operatively coupled to the amplifier, and a feedback path operatively coupled between the detector and the amplifier. The amplifier is configured to receive and amplify an input signal received by the read channel circuitry. The detector is configured to detect a data pattern from the amplified input signal. The feedback path is configured to provide a feedback signal to the amplifier to adjust a gain of the amplifier, and to generate the feedback signal in accordance with a value selected to improve detection of the data pattern by increasing an amplitude of the data pattern around a given frequency.

### FIELD

The field relates generally to signal processing, and, more particularly, to processing of data signals.

### BACKGROUND

Gain control is a signal processing technique typically used to adjust a signal level of an amplifier stage of a circuit. For example, automatic gain control (AGC) is employed to automatically change the gain of a circuit so that the amplitude of a desired output signal generated by the circuit remains essentially constant or within some suitable range despite variations in input signal strengths associated with interference or other interruptions of the signal level. AGC is known to be used in read channels of hard disk drive systems. In such read channels, an amplitude-controlled analog data signal is converted to a digital signal before being further processed and detected. Furthermore, in such read channels, a data pattern with frequency content at or close to the Nyquist frequency (i.e., referred to as a “Nyquist data pattern”) is typically read from the magnetic medium of the disk drive system. However, the Nyquist data pattern is known to be error prone due to small signal energy at or near the Nyquist frequency. With limited analog-to-digital (ADC) converter resolution, the already small signal energy of the Nyquist data patterns is further compromised due to quantization noise. The detection of the Nyquist data pattern is also sensitive to the quality of the AGC.

### SUMMARY

Embodiments of the invention provide for processing of data signals and, in particular, provide for automatic gain control loop adaptation in circuitry for processing such data signals.

In one embodiment of the invention, an apparatus comprises read channel circuitry and signal processing circuitry associated with the read channel circuitry. The signal processing circuitry comprises an amplifier, a detector operatively coupled to the amplifier, and a feedback path operatively coupled between the detector and the amplifier. The amplifier is configured to receive and amplify an input signal received by the read channel circuitry. The detector is configured to detect a data pattern from the amplified input signal. The feedback path is configured to provide a feedback signal to the amplifier to adjust a gain of the amplifier, and to generate the feedback signal in accordance with a value selected to improve detection of the data pattern by increasing an amplitude of the data pattern around a given frequency.

For example, the value is selected to at least reduce quantization distortion associated with the data pattern, and the data pattern comprises frequency content around a Nyquist frequency associated with the signal processing circuitry (e.g., a Nyquist data pattern).

Alternative embodiments of the invention including but not limited to methods, integrated circuits and computer-readable storage media provide other implementations of automatic gain control loop adaptation described herein in order to improve data detection.

### BRIEF DESCRIPTION OF THE FIGURES

FIG. 1 shows a disk-based storage device according to an embodiment of the invention.

FIG. 2 is a detailed view of portions of the signal processing circuitry of FIG. 1 with automatic gain control loop adaptation according to an embodiment of the invention.

FIG. 3 is an automatic gain control loop adaptation methodology according to an embodiment of the invention.

FIG. 4 shows a virtual storage system incorporating a plurality of disk-based storage devices of the type shown in FIG. 1 according to an embodiment of the invention.

### DETAILED DESCRIPTION

Embodiments of the invention will be illustrated herein in conjunction with exemplary disk-based storage devices, read channel circuitry and associated signal processing circuitry for processing read channel data signals. It should be understood, however, that these and other embodiments of the invention are more generally applicable to any device or system in which improved signal processing is desired. Additional embodiments may be implemented using components other than those specifically shown and described in conjunction with the illustrative embodiments. By way of example only, alternative embodiments are employed in transceivers and/or receivers in communications systems including, but not limited to, wireless communications systems.

In the detailed description to follow, certain acronyms will be used. For convenience, below is a reference list of acronyms used:

ADC—Analog-to-Digital Converter

AGC—Automatic Gain Control

BER—Bit Error Rate

BLC—Base Line Compensation

CTF—Continuous Time Filter

DAC—Digital-to-Analog Converter

DC—Direct Current

DFIR—Digital Finite Impulse Response

HDD—Hard Disk Drive

LMS—Least Mean Square

LSB—Least Significant Bit

MRAC—Magnetic Response Asymmetry Compensation

NPFIR—Noise Predictive Finite Impulse Response

NRZ—Non-Return-to-Zero

RAID—Redundant Array of Independent Storage Devices

RPM—Revolutions Per Minute

SNR—Signal-to-Noise Ratio

SOYA—Soft-Output Viterbi Algorithm

VGA—Variable Gain Amplifier

ZF—Zero Forcing

As mentioned above, a Nyquist data pattern read from the magnetic medium of the hard disk drive (HDD) system is error prone. Actually, it has the highest error rate compared to other data patterns read from the magnetic medium of the HDD system. Improving the detection of Nyquist data pattern in accordance with embodiments of the invention can improve the reliability of the HDD system.

The Nyquist data pattern usually has a relatively small signal amplitude close to zero due to anti-aliasing filtering and/or low pass channel properties. Existing AGC loop adaptation algorithms drive the AGC gain to a level such that data patterns with the most power in the frequency domain have minimum quantization distortion. Unfortunately, the resulting AGC gain is too small for Nyquist data patterns and the signal information is lost or severely distorted after analog-to-digital (ADC) quantization.

That is, due to anti-aliasing filtering and/or channel impulse response, the received signal after the ADC exhibits low energy around the Nyquist frequency. The Nyquist frequency refers to a frequency equal to half the baud rate of the read channel receiver or half the sampling frequency of the ADC. The read channel receiver is sensitive to the signal-to-noise ratio (SNR) around the Nyquist frequency. Since the signal level around the Nyquist frequency is normally small, the quantization noise can be too large for the small signal level. The ensuing loss or distortion of data makes the accurate detection of Nyquist data patterns difficult, thus adversely affecting the ability to correctly detect the recorded data of an HDD system.

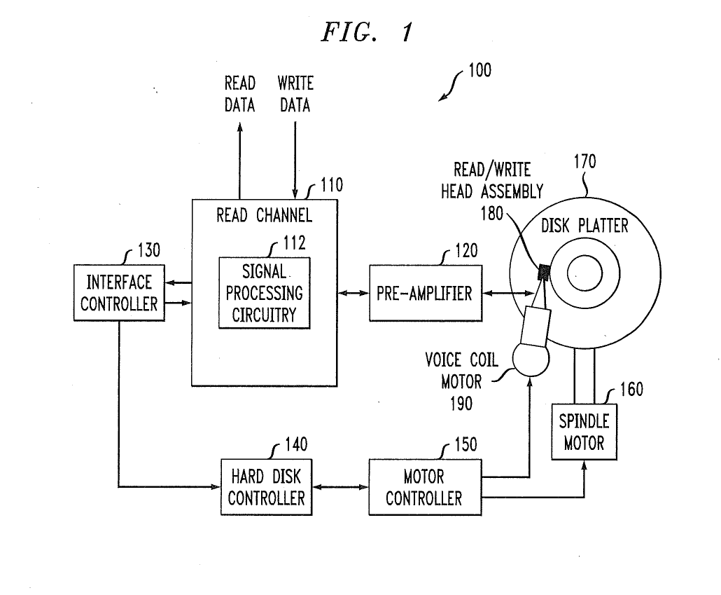

As will be explained below in the context of FIGS. 1-4, embodiments of the invention provide automatic gain control loop adaptation techniques for increasing the signal level around the Nyquist frequency to reduce the quantization noise and thus improve detection performance, e.g., improve a bit error rate (BER) of a detector of the system.

Referring initially to FIG. 1, a disk-based storage device 100 is shown. The storage device includes read channel circuitry 110 having signal processing circuitry 112 in accordance with various embodiments of the invention. Although shown in FIG. 1 as being incorporated within read channel circuitry 110, the signal processing circuitry 112 may also be implemented at least in part externally to the read channel circuitry 110. Storage device 100 may be, for example, a hard disk drive. Storage device 100 also includes a preamplifier 120, an interface controller 130, a hard disk controller 140, a motor controller 150, a spindle motor 160, a disk platter 170, read/write head assembly 180, and voice coil motor 190. Interface controller 130 controls addressing and timing of data to and from disk platter 170. In some embodiments, disk platter 170 (magnetic medium) includes magnetic signals recorded in accordance with either a longitudinal or a perpendicular recording scheme. The read/write head assembly 180 may comprise separate read and write heads or a single combined read/write head.

Read/write head assembly 180 is positioned by voice coil motor 190 over a desired data track on disk platter 170. Motor controller 150 controls the voice coil motor 190 to position read/write head assembly 180 in relation to disk platter 170 and drives spindle motor 160 by moving read/write head assembly to the proper data track on disk platter 170 under direction of the hard disk controller 140. Spindle motor 160 spins disk platter 170 at a determined spin rate in revolutions per minute (RPM).

Once read/write head assembly 180 is positioned adjacent the proper data track, magnetic signals representing data on disk platter 170 are sensed by read/write head assembly 180 as disk platter 170 is rotated by spindle motor 160. The sensed magnetic signals are provided as an analog signal representative of the magnetic data on disk platter 170. This analog signal is transferred from read/write head assembly 180 to read channel circuitry 110 via preamplifier 120. Preamplifier 120 is operable to amplify the analog signals accessed from disk platter 170. In turn, read channel circuitry 110 decodes and digitizes the received analog signal to recreate the information originally written to disk platter 170. This data is provided as read data.

In the illustrative data detection scenario mentioned above, the read data includes Nyquist data pattern, and the signal processing circuitry 112 performs, inter alia, automatic gain control loop adaptation to boost the signal level around the Nyquist frequency to improve data pattern detection.

Various elements of the storage device 100 may be implemented at least in part within a processing device. A processing device includes a processor and a memory, and may be implemented at least in part within an associated host computer or server in which the storage device 100 is installed. Portions of the processing device may be viewed as comprising “control circuitry” as that term is broadly used herein.

It is important to note that storage device 100 may include other elements in addition to or in place of those specifically shown, including one or more elements of a type commonly found in a conventional implementation of such a storage device. These and other conventional elements, being well understood by those skilled in the art, are not described in detail herein. It should also be understood that the particular arrangement of elements shown in FIG. 1 is presented by way of illustrative example only. Those skilled in the art will recognize that a wide variety of other storage device configurations may be used in implementing embodiments of the invention.

Embodiments of the invention boost the signal level around the Nyquist frequency to reduce quantization noise and thus improve performance associated with detecting the Nyquist data pattern. Examples of such Nyquist data patterns include, but are not limited to, binary data strings such as “010” or “101”, and “010101” or “101010”. Of course, binary patterns with more or less bits and in varying orders are also referred as the Nyquist data patterns. It is to be understood that while embodiments of the invention relate to Nyquist data pattern detection, alternative embodiments are used to detect other types of data signals.

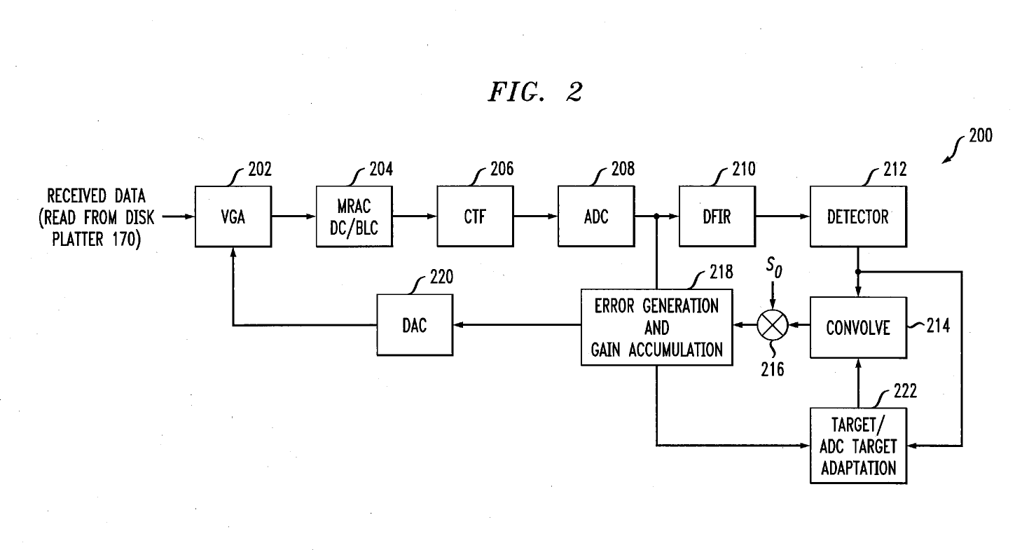

FIG. 2 shows an example of portions of the signal processing circuitry 112 shown in FIG. 1 with automatic gain control loop adaptation functionality. It is to be understood, however, that various elements shown in circuitry 200 of FIG. 2 may alternatively be implemented outside the read channel circuitry 110.

As shown operatively coupled in FIG. 2, circuitry 200 includes a variable gain amplifier (VGA) 202, a compensator 204, a continuous time filter 206, an analog-to-digital converter 208, a digital finite impulse response (DFIR) filter 210, a detector 212, a convolver 214, a multiplier 216, an error generator and gain accumulator 218, a digital-to-analog converter 220 and a target adaptor 222.

It is assumed that the data received by circuitry 200 is obtained from the disk platter 170 via the read/write head assembly 180 and the pre-amplifier 120. The VGA 202 inputs the analog signal from the pre-amplifier 120 and initially sets the signal level to a range suitable for the ADC 208, The VGA 202 provides the analog signal to the compensator 204.

The compensator 204 receives the initially amplified analog signal from the VGA 202 and performs one or more analog compensation operations on the analog signal to reduce or eliminate signal distortions. For example, magnetic response asymmetry compensation (MRAC), direct current (DC) offset and/or base line wander compensation (BLC) are performed on the analog signal. The compensator 204 provides the distortion-compensated analog signal to the CTF 206.

The CTF 206 receives the distortion-compensated analog signal from the compensator 204 and shapes the read channel impulse response and performs anti-aliasing filtering on the analog signal. The CTF 206 provides the continuous time-filtered analog signal to the ADC 208.

The ADC 208 receives the continuous time-filtered analog signal and converts the analog signal to a digital signal. In the ADC 208, a digital signal is generated by sampling the continuous time-filtered analog signal and then quantizing the samples. Quantization is the operation of mapping a larger set of values to a smaller set of values such as, by way of example, rounding values to some unit of precision. The difference between an input analog signal and the quantized digital signal is referred to as “quantization error” or “quantization distortion.” This error or distortion is typically either due to rounding or truncation, and may also be referred to as “quantization noise.” The ADC 208 provides the quantized digital signal to the DFIR 210.

The DFIR filter 210 receives the quantized digital signal and performs an equalization operation on the signal. Equalization is the operation of adjusting the balance between frequency components of a digital signal and shaping the spectrum of a signal to a desired shape. This is accomplished by the DFIR filter (which may include one or more DFIR filters). The DFIR filter 210 provides the equalized digital signal to the detector 212.

The detector 212 receives the equalized digital signal and attempts to detect data content in the equalized digital signal. In some embodiments of the invention, the detector 212 comprises a soft-output Viterbi algorithm (SOYA) detector which includes a number of noise predictive finite impulse response (NPFIR) filters. In other embodiments of the invention, the detector 212 comprises a maximum a posteriori probability (MAP) detector or a combination of SOVA and MAP detectors. Other forms of detectors may be employed in alternative embodiments. The detector 212 effectively generates an estimation of the data read from the disk platter 170. That is, in automatic gain control loop adaptation embodiments of the invention, the detector 212 attempts to detect the Nyquist data pattern obtained from the disk platter 170. The detector 212 provides the estimated digital signal (symbols) to the convolver 214.

The convolver 214 receives the estimated data symbols (for read channels of the HDD systems, the data symbols are binary Non-Return-to-Zero (NRZ) symbols recorded on the magnetic medium) from the detector 212 and convolves the estimated data symbols with the target filter in 222 which is a digital filter with an impulse response close to the real ADC channel impulse response, i.e., the target filter 222 is an approximation of the true ADC channel impulse response. The taps of the target filter can be fixed or adapted. The multiplication of the scalar value at multiplier 216, which will be further explained below, and the convolved digital signal at the output of 214 generates the desired ADC samples which contain the desired amplitude information of the analog signal from the VGA 202.

However, as mentioned above, the Nyquist data pattern typically exhibits a relatively small signal amplitude close to zero due to anti-aliasing filtering and/or low pass channel response properties. Thus, the quantization noise introduced by the ADC 208 can overshadow the small signal level of the Nyquist data pattern. As such, the multiplier 216 gives extra boost to the Nyquist data pattern.

The multiplier 216 multiplies the digital signal from the convolver 214 with a scalar value S₀. This process is given by the following equation:

[symbol]

=S₀*(Σᵢ₌₀^{L-1}tᵢ*\hat{d}ₖ₋ᵢ). (1)

In equation (1), t₀, t₁, . . . , t_{L-1} are the coefficients of the target filter in 222; \hat{d}ₖ₋ᵢ is the estimated data symbol at time k−i from detector 212 and \hat{x}\hat{xₖ} is the scaled signal after the multiplier 216.

In the received analog signal read from the disk platter 170, low frequency data patterns (data patterns with frequency contents significantly distant from the Nyquist frequency) have considerably higher signal amplitude than Nyquist data patterns. For the ADC 208 with a limited dynamic range, the low frequency data patterns prefer a lower VGA 202 gain value while the Nyquist data patterns prefer a higher gain value. Due to the anti-aliasing filtering and the low pass property of the read channel, the energy of the received analog signal is dominated by the energy of low pass data patterns. So, the VGA 202 settles down with a low gain value that is preferred by low frequency data patterns not the Nyquist data patterns. The scalar value Sₒ is selected such that the AGC loop forces the VGA 202 to settle down with a larger gain value to provide extra boost to the Nyquist data patterns. Due to the larger VGA gain value forced by the scalar in the AGC loop, the signal amplitude of the Nyquist data pattern before ADC is enhanced, which makes the Nyquist data pattern more immune to ADC quantization distortion and easier to be detected. The scalar S₀ is programmable and, in one or more embodiments of the invention, is set to a number greater than 1 and in the range of [1, 1.25]. With this scalar value, the low frequency data patterns are slightly saturated at the ADC 208. The effects of this on detector error rate performance are compensated by the effects of reduced quantization noise for Nyquist data patterns at the ADC 208 since Nyquist data patterns are more vulnerable to quantization noise and more prone to errors compared to low frequency data patterns. However, the scalar S₀ should not be set beyond this range otherwise the quantization noise increases too much for low frequency data patterns, which degrades the detector error rate performance.

The location at which to add the scalar S₀ is chosen in the AGC loop to boost the desired target signal amplitude at the output of the convolver 214 such that the AGC loop automatically adjusts the VGA 202 gain to force the signal amplitude at the output of ADC 208 to match that of the multiplier 216. The scalar S₀ should not be placed in the analog path before ADC 208 because the gain of the VGA 202 would decrease to compensate the boost of the scalar S₀ if the reference target signal at the output of convolver 214 is not boosted. For the same reason, neither should the scalar S₀ be placed in the digital forward path from ADC 208 to DFIR 210 to detector 212. Thus, as shown, the scalar-enhanced digital signal is provided to the error generator in 218.

The error generator in 218 receives the scalar-enhanced digital signal from the multiplier 216 and generates an error signal based on the scalar-enhanced digital signal and the quantized digital signal output by the ADC 208. The error signal is the difference between the quantized digital signal and the scalar-enhanced digital signal. This process is given by the following equation:

eₖ=xₖ− [symbol] . (2)

In Equation 2, xₖ is the ADC 208 output at time k. The error signal eₖ is used to generate the gain control signal by a gain accumulator in accordance with following equation:

g_{k+1+Δ}=g_{k+Δ}−GUG*xₖ*eₖ. (3)

In Equation 3, g_{k+Δ} is the digital gain control signal at time k+Δ and Δ is a non-negative integer to account for the processing time needed to get the error signal; GUG is the update gain to control the bandwidth of the AGC loop. Please note Equation 3 is a Least Mean Square (LMS) adaptation and a Zero Forcing (ZF) adaptation can also be used in accordance with the following equation:

g_{k+1+Δ}=g_{k+Δ}−GUG* [symbol] *eₖ. (4)

The digital gain control signal g_{k+1+Δ} is converted to an analog signal by DAC 220 before it is applied to the VGA 202 to adjust the amplitude of the received signal.

The DAC 220 receives the gain signal from the gain accumulator in 218 and converts the digital gain signal to an analog gain signal. The analog gain signal is then applied to the VGA 202 to automatically control the gain of the VGA 202. Please note that the conversion of the digital gain signal to analog gain signal can be either linear or exponential. It is to be appreciated that the scalar enhancement (S₀) applied by the multiplier 216 to the detected digital signal adapts the gain control signal applied to the VGA 202 thereby improving the performance (e.g., BER improvement) of the detector 212. The scalar S₀ enhances the VGA 202 gain through the AGC loop in the following way. The desired signal amplitude is increased by the multiplier 216, i.e., equation (1); then the AGC loop, through the process represented by Equations 1 to 4, forces the VGA 202 gain to a greater value such that the signal amplitude at the ADC 208 output approaches the enhanced desired signal amplitude in Equation 1.

The benefit of the properly enhanced VGA 202 gain is that the Nyquist data pattern is more immune to the quantization noise at ADC 208 than would otherwise be the case. The main reason is as follows. Let A_{LSB} be the signal amplitude corresponding to the Least Significant Bit (LSB) level in the ADC 208. Any analog signal with amplitude smaller than A_{LSB} is quantized to 0 at ADC 208 and the data information gets lost, which happens with a higher frequency to the Nyquist data patterns if the VGA 202 gain value is smaller compared to a greater VGA 202 gain value which is achieved by adding the scalar S₀ enhancement 216 in the AGC loop. With the reduced quantization noise on Nyquist data patterns, the detector 212 detects the Nyquist data patterns with less error rate.

Note also that the target filter in 222 can be either fixed or adapted. In the case of an adapted target filter, the error signal generated by the error generator in 218 and the estimated data symbols generated by the detector 212 are provided to the target adaptor in 222. The target adaptor 222 adjusts the target response signal based on the error signal and the estimated data symbols such that the error eₖ, generated in 218, between the ADC 208 output xₖ and the enhanced target response signal \hat{x}\hat{xₖ} is minimized. Various adaptation algorithms can be used with LMS adaptation being one example.

It is to be understood that the convolver 214, the multiplier 216, the error generator and gain accumulator in 218 and the DAC 220 form a feedback path between the output of the detector 212 and the VGA 202. The feedback path thus enables automatic gain control loop adaptation in the signal processing circuitry of the read channel. The control loop, in one embodiment, comprises at least a portion of the elements shown in the circuitry 200 of FIG. 2. Other elements (not shown) may be included in the feedback path and/or the control loop.

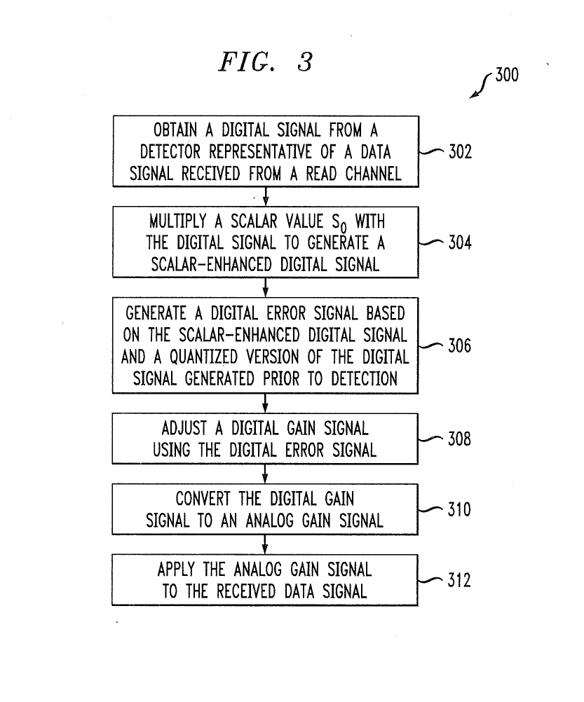

FIG. 3 illustrates an automatic gain control loop adaptation methodology 300 in accordance with an embodiment of the invention. It is to be appreciated that steps 302-312 can be performed via at least a portion of the feedback path of circuitry 200 described above in the context of FIG. 2.

The methodology 300 begins with step 302, wherein a digital signal is obtained from a detector (e.g., detector 212) representative of a data signal received from a read channel (e.g., read channel 110). In step 304, a scalar value (e.g., S₀) is multiplied with the digital signal to generate a scalar-enhanced digital signal. In step 306, a digital error signal is generated based on the scalar-enhanced digital signal and a quantized version of the digital signal generated prior to detection (e.g., as output by ADC 208). In step 308, the digital error signal is used to adjust a digital gain signal. In step 310, the digital gain signal is converted to an analog gain signal. The analog gain signal is then applied to the received data signal in step 312 so as to reduce quantization distortion for the received data signal particularly for data patterns around the Nyquist frequency.

As mentioned previously, the storage device configuration can be implemented can be varied in other embodiments of the invention. For example, the storage device may comprise a hybrid HDD which includes a flash memory in addition to one or more storage disks. Also, the process or portions thereof as described above in methodology 300 may be implemented in the form of software that is stored in a memory and executed by a processor. Such a memory may be viewed as an example of what is more generally referred to as a computer-readable storage medium comprising executable program code.

In addition, storage device 100 may be coupled to or incorporated within a host processing device, which may be a computer, server, communication device, etc.

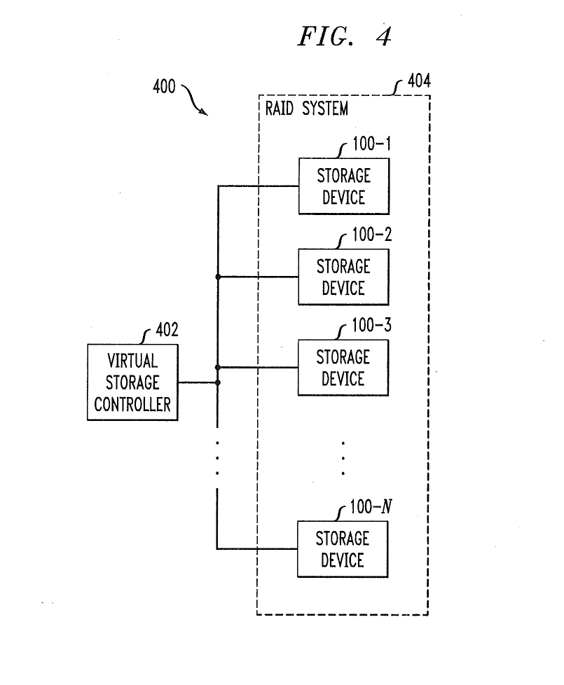

Multiple storage devices 100-1 through 100-N possibly of various different types may be incorporated into a virtual storage system 400 as illustrated in FIG. 4. The virtual storage system 400, also referred to as a storage virtualization system, illustratively comprises a virtual storage controller 402 coupled to a RAID system 404, where RAID denotes Redundant Array of Independent storage Devices. The RAID system more specifically comprises N distinct storage devices denoted 100-1, 100-2, . . . 100-N, one or more of which may be HDDs and one or more of which may be solid state drives. Furthermore, one or more of the HDDs of the RAID system are assumed to be configured to include read channel circuitry and associated automatic gain control loop adaptation circuitry as disclosed herein. These and other virtual storage systems comprising HDDs or other storage devices are considered embodiments of the invention.

Embodiments of the invention may also be implemented in the form of integrated circuits. In a given such integrated circuit implementation, identical die are typically formed in a repeated pattern on a surface of a semiconductor wafer. Each die includes, for example, at least a portion of signal processing circuitry 112 as described herein, and may further include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

It should again be emphasized that the above-described embodiments of the invention are intended to be illustrative only. For example, other embodiments can use different types and arrangements of storage disks, read/write heads, read channel circuitry, signal processing circuitry, decoders, filters, detectors, and other storage device elements for implementing the described functionality. Also, the particular manner in which certain steps are performed in the signal processing may vary. Further, although embodiments of the invention have been described with respect to storage disks such as HDDs, embodiments of the invention may be implemented in various other devices including optical data-storage applications and wireless communications. These and numerous other alternative embodiments within the scope of the following claims will be apparent to those skilled in the art.

1. An apparatus, comprising:
read channel circuitry; and
signal processing circuitry associated with the read channel circuitry, the signal processing circuitry comprising:
an amplifier, the amplifier being configured to receive and amplify an input signal received by the read channel circuitry;
a detector operatively coupled to the amplifier, the detector being configured to detect a data pattern from the amplified input signal and to generate a detected digital signal representing the data pattern; and
a feedback path operatively coupled between the detector and the amplifier, the feedback path being configured to provide a feedback signal to the amplifier to adjust a gain of the amplifier, wherein the feedback path generates the feedback signal in accordance with a value selected to improve detection of the data pattern by increasing an amplitude of the data pattern around a given frequency;
wherein the feedback path further comprises a multiplier operatively coupled to the detector and configured to multiply the value with the detected digital signal.

2. The apparatus of claim 1, wherein the value is selected to at least reduce quantization distortion associated with the data pattern.

3. The apparatus of claim 2, wherein the data pattern comprises frequency content around a Nyquist frequency associated with the signal processing circuitry.

4. The apparatus of claim 1, wherein the signal processing circuitry further comprises an analog-to-digital converter operatively coupled between the amplifier and the detector, the analog-to-digital converter being configured to sample and quantize the amplified input signal to generate a quantized digital signal.

5. An apparatus, comprising:
read channel circuitry; and
signal processing circuitry associated with the read channel circuitry, the signal processing circuitry comprising:
an amplifier, the amplifier being configured to receive and amplify an input signal received by the read channel circuitry;
a detector operatively coupled to the amplifier, the detector being configured to detect a data pattern from the amplified input signal;
an analog-to-digital converter operatively coupled between the amplifier and the detector, the analog-to-digital converter being configured to sample and quantize the amplified input signal to generate a quantized digital signal;
a feedback path operatively coupled between the detector and the amplifier, the feedback path being configured to provide a feedback signal to the amplifier to adjust a gain of the amplifier, wherein the feedback path generates the feedback signal in accordance with a value selected to improve detection of the data pattern by increasing an amplitude of the data pattern around a given frequency;
wherein the feedback path further comprises a scalar multiplier operatively coupled to the detector and configured to multiply the value, which is a scalar, with a detected digital signal generated by the detector responsive to the quantized digital signal, wherein the detected digital signal represents the data pattern.

6. The apparatus of claim 5, wherein the feedback path further comprises an error generator and a gain accumulator operatively coupled to the scalar multiplier and the analog-to-digital converter, and configured to generate a digital error signal and a digital gain signal in response to the scalar multiplied digital signal and the quantized digital signal.

7. The apparatus of claim 6, wherein the feedback path further comprises a digital-to-analog converter operatively coupled between the gain accumulator and the amplifier, and configured to convert the digital gain signal to an analog gain control signal.

8. The apparatus of claim 7, wherein the analog gain control signal is the feedback signal and is applied to the amplifier to adjust the gain of the amplifier.

9. The apparatus of claim 1, wherein the read channel circuitry and associated signal processing circuitry are fabricated in at least one integrated circuit.

10. A storage device comprising:
at least one storage medium;
a read head configured to read data from the storage medium; and
control circuitry coupled to the read head and configured to process data received from the read head;
the control circuitry comprising the apparatus of claim 1.

11. A virtual storage system comprising the storage device of claim 10.

12. A method comprising the steps of:
amplifying an input signal;
detecting a data pattern from the amplified input signal to generate a detected digital signal representing the data pattern;
generating a feedback signal to adjust a gain of the amplified signal, wherein the feedback signal is generated in accordance with a value selected to improve detection of the data pattern by increasing an amplitude of the data pattern around a given frequency;
wherein generating the feedback signal comprises multiplying the value with the detected digital signal.

13. The method of claim 12, wherein the value is selected to at least reduce quantization distortion associated with the data pattern.

14. The method of claim 13, wherein the data pattern comprises frequency content around a Nyquist frequency.

15. The method of claim 12, further comprising sampling and quantizing the amplified input signal to generate a quantized digital signal.

16. A method comprising the steps of:
amplifying an input signal;
detecting a data pattern from the amplified input signal;
generating a feedback signal to adjust a gain of the amplified signal, wherein the feedback signal is generated in accordance with a value selected to improve detection of the data pattern by increasing an amplitude of the data pattern around a given frequency;
sampling and quantizing the amplified input signal to generate a quantized digital signal; and
multiplying the value with a detected digital signal generated responsive to the quantized digital signal, wherein the detected digital signal represents the data pattern.

17. The method of claim 16, further comprising generating a digital error signal and a digital gain signal in response to the value multiplied digital signal and the quantized digital signal.

18. The method of claim 17, further comprising converting the digital gain signal to an analog gain control signal.

19. The method of claim 18, wherein the analog gain control signal is the feedback signal, and further comprising applying the analog gain control signal to the input signal to adjust the gain of the amplified input signal.

20. An apparatus comprising:
an amplifier, the amplifier being configured to receive and amplify an input signal;
a detector operatively coupled to the amplifier, the detector being configured to detect a data pattern from the amplified input signal and to generate a detected digital signal representing the data pattern; and
a feedback path operatively coupled between the detector and the amplifier, the feedback path being configured to provide a feedback signal to the amplifier to adjust a gain of the amplifier, wherein the feedback path generates the feedback signal in accordance with a value selected to improve detection of the data pattern by increasing an amplitude of the data pattern around a given frequency.
wherein the feedback path further comprises a multiplier operatively coupled to the detector and configured to multiply the value with the detected digital signal.
